(19) United States
(12) Patent Application Publication
(10) Pub. No.: US 2013/0144420 A1
(43) Pub. Date: Jun. 6, 2013

(54) Systems For Controlling Surface Profiles Of Wafers Sliced In A Wire Saw

(71) Applicants: Carlo Zavattari, Varallo Pombia (IT); Ferdinando Severico, Cavaglietto (IT); Sumeet S. Bhagavat, St. Peters, MO (US); Gabriele Vercelloni, Novara (IT); Roland R. Vandamme, Wentzville, MO (US)

(72) Inventors: Carlo Zavattari, Varallo Pombia (IT); Ferdinando Severico, Cavaglietto (IT); Sumeet S. Bhagavat, St. Peters, MO (US); Gabriele Vercelloni, Novara (IT); Roland R. Vandamme, Wentzville, MO (US)

(73) Assignee: MEMC ELECTRONIC MATERIALS, SPA, Novara (IT)

(21) Appl. No.: 13/309,243

(22) Filed: Dec. 1, 2011

(51) Int. Cl. G05D 23/19; G06F 19/00; G05D 7/06; B28D 5/00

(52) U.S. Cl. 700/108; 125/12

(57) ABSTRACT

Systems are disclosed for controlling the surface profiles of wafers cut in a wire saw machine. The systems and methods described herein are generally operable to alter the nanotopology of wafers sliced from an ingot by controlling the shape of the wafers. The shape of the wafers is altered by changing the temperature and/or flow rate of a temperature-controlling fluid circulated in fluid communication with bearings supporting wire guides of the saw. Different feedback systems can be used to determine the temperature of the fluid necessary to generate wafers having the desired shape and/or nanotopology.

### FIELD

This disclosure relates generally to wire saw machines used to slice ingots into wafers and, more specifically, to systems for controlling the surface profiles of wafers sliced in the wire saw machines.

### BACKGROUND

Semiconductor wafers are typically formed by cutting an ingot with a wire saw machine. These ingots are often made of silicon or other semiconductor or solar grade material. The ingot is connected to structure of the wire saw by a bond beam and an ingot holder. The ingot is bonded with adhesive to the bond beam, and the bond beam is in turn bonded with adhesive to the ingot holder. The ingot holder is connected by any suitable fastening system to the wire saw structure.

In operation, the ingot is contacted by a web of moving wires in the wire saw that slice the ingot into a plurality of wafers. The bond beam is then connected to a hoist and the wafers are lowered onto a cart.

Wafers cut by known saws may have surface defects that cause the wafers to have nanotopology that deviates from set standards. In order to ameliorate the deviating nanotopology, such wafers may be subject to additional processing steps. These steps are time-consuming and costly. Moreover, known wire saw machines are not operable to adjust the shape and/or warp of the surfaces of the wafers cut from the ingot by the machines. Thus, there exists a need for a more efficient and effective system to control nanotopology of wafers cut in a wire saw machine.

This section is intended to introduce the reader to various aspects of art that may be related to various aspects of the disclosure, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

### SUMMARY

One aspect is a system for controlling the surface profile of wafers sliced from an ingot in a wire saw, the wire saw including a wire guide supporting wires, the wire guide rotating on a bearing, and a fluid in thermal communication with the bearing. The system comprises a memory for storing temperature profiles, each temperature profile associated with a surface profile and defining a temperature set point for at least one of the fluid and the bearing, a control system for controlling the temperature of the bearing, a temperature sensor for measuring the temperature of at least one of the fluid and the bearing, and a processor communicatively coupled to the memory, control system, and temperature sensor, the processor configured for receiving an input identifying a desired surface profile and retrieving the associated temperature set point from the memory, the processor configured for communicating instructions to the control system to control the temperature of the bearing based at least in part on the temperature set point and measured temperature of at least one of the fluid and the bearing.

Another aspect is a system for controlling surface profiles of wafers cut from an ingot by a wire saw. The system comprises a wafer measurement sensor for measuring a surface of the wafer previously cut by the wire saw, a sensor disposed for measuring displacement of a bearing of a wire guide supporting wires in the wire saw, and a processor for determining a temperature set point, the processor configured for determining the temperature set point based at least in part on one of the measured displacement of the bearing and measured surface of the previously cut wafer, the processor communicatively coupled to the wafer measurement sensor and the sensor.

Still another aspect is a system for controlling the surface profile of wafers sliced from an ingot in a wire saw, the wire saw including a wire guide supporting wires, the wire guide rotating on a bearing, and a fluid in thermal communication with the bearing. The system comprises a memory for storing temperature profiles, each temperature profile associated with a surface profile and defining a temperature set point for the bearing, a valve for controlling the flow rate of the fluid, a temperature sensor for measuring the temperature of the bearing, and a processor communicatively coupled to the memory, valve, and temperature sensor, the processor configured for receiving an input identifying a desired surface profile and retrieving the associated temperature set point from the memory, the processor configured for communicating instructions to the valve to control the flow rate of the fluid based at least in part on the temperature set point and measured temperature of the bearing.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a perspective view of a system including an ingot and a wire saw machine;

FIG. 2 is an end view of the system of FIG. 1;

FIG. 3 is a left side view of the system of FIG. 1;

FIG. 4 is a Graph showing the relationship between bearing displacement and time as the ingot is cut by the wire saw machine;

FIG. 5 is a Graph showing the relationship between bearing temperature and bearing displacement; and

FIG. 6 is a Graph showing the relationship between bearing displacement and wafer shape.

Corresponding reference characters indicate corresponding parts throughout the several views of the drawings.

### DETAILED DESCRIPTION

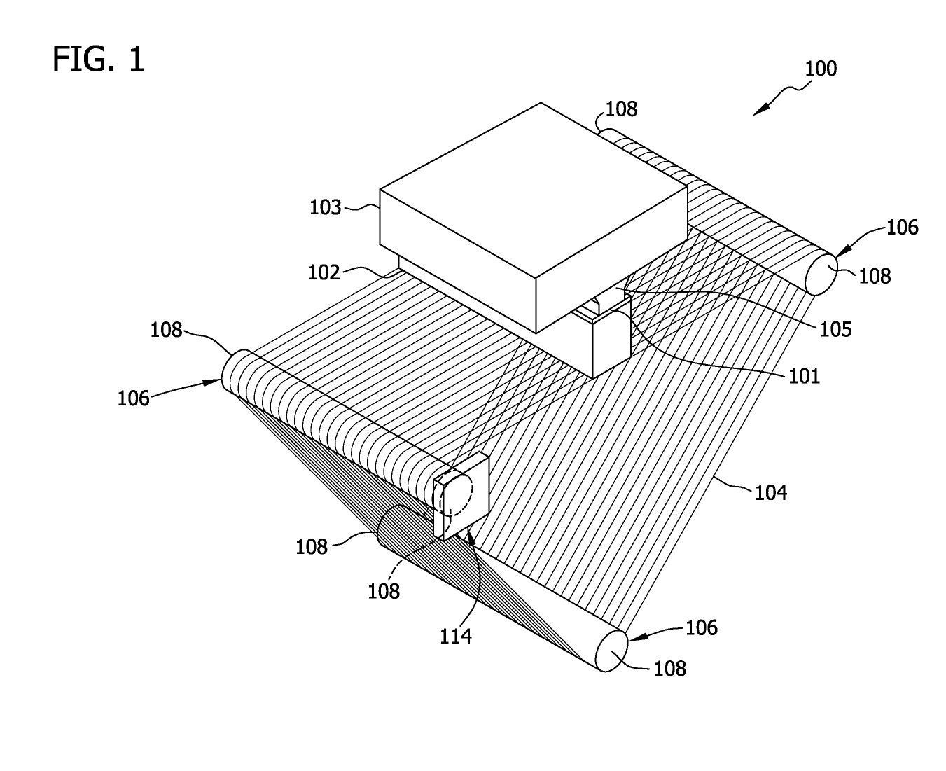

Referring to the drawings, an exemplary system for controlling the surface profile of wafers cut from an ingot 102 by a wire saw machine 103 is shown in FIG. 1 and indicated generally at 100. As used herein, the terms “surface profile” or “wafer surface profile” refer to both the nanotopology and shape of the surfaces of wafers.

The systems and methods described herein are generally operable to control the shape, and thus the nanotopology, of wafers sliced from an ingot by controlling the shape of the wafers. The shape of the wafers may be controlled by controlling the temperature of bearings supporting wire guides of the saw. The temperature of the bearings is controlled by controlling the temperature of a temperature-controlling fluid circulated in fluid communication with the bearings and/or controlling the flow rate of the fluid. Different feedback systems may be used to determine the temperature of the fluid and/or bearings necessary to generate wafers having the desired shape and/or nanotopology, though such feedback systems are not required. Moreover, systems and methods may used to store and retrieve recipes defining temperature and/or displacement profiles for the fluid and/or bearings which correspond to desired surface profiles. Embodiments of the systems and methods described herein are operable to reduce or eliminate the entry and/or exit marks formed in the surfaces of wafers cut in wire saw machines.

Nanotopology has been defined as the deviation of a wafer surface within a spatial wavelength of about 0.2 mm to about 20 mm. This spatial wavelength corresponds very closely to surface features on the nanometer scale for processed semiconductor wafers. The foregoing definition has been proposed by Semiconductor Equipment and Materials International (SEMI), a global trade association for the semiconductor industry (SEMI document 3089). Nanotopology measures the elevational deviations of one surface of the wafer and does not consider thickness variations of the wafer, as with traditional flatness measurements. Several meteorology methods have been developed to detect and record these kinds of surface variations. For instance, the measurement deviation of reflected light from incident light allows detection of very small surface variations. These methods are used to measure peak to valley (PV) variations within the wavelength. Nanotopology can be predicted or estimated based on measurements taken of the surface of the wafer after it has been sliced, but before it is subject to polishing.

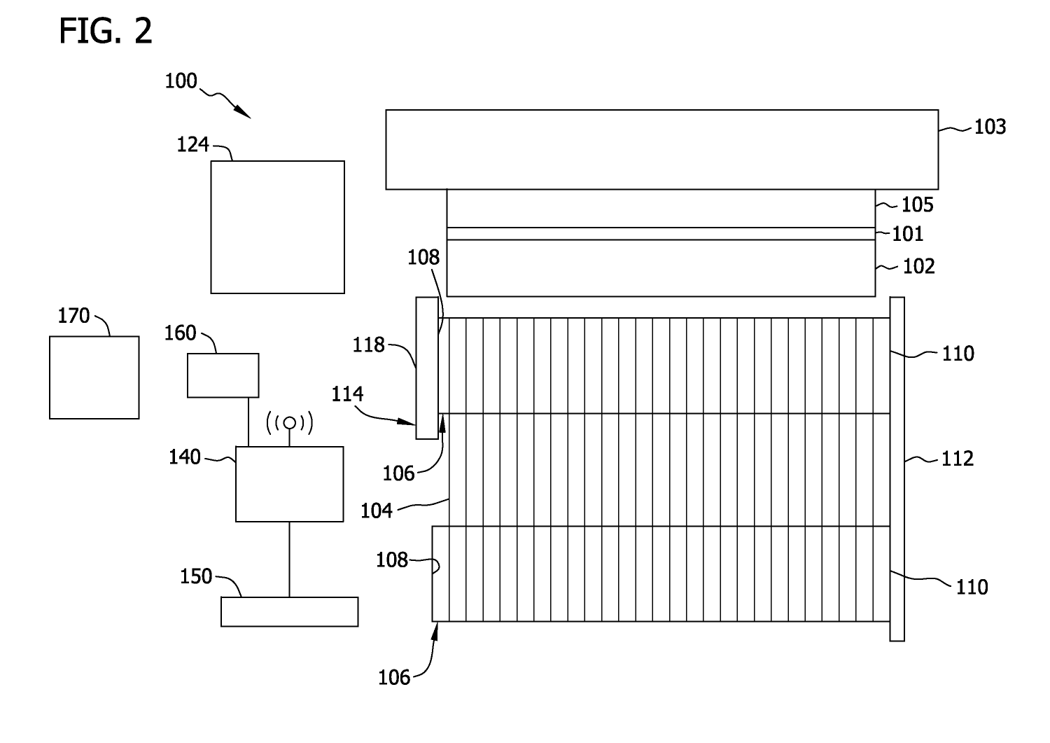

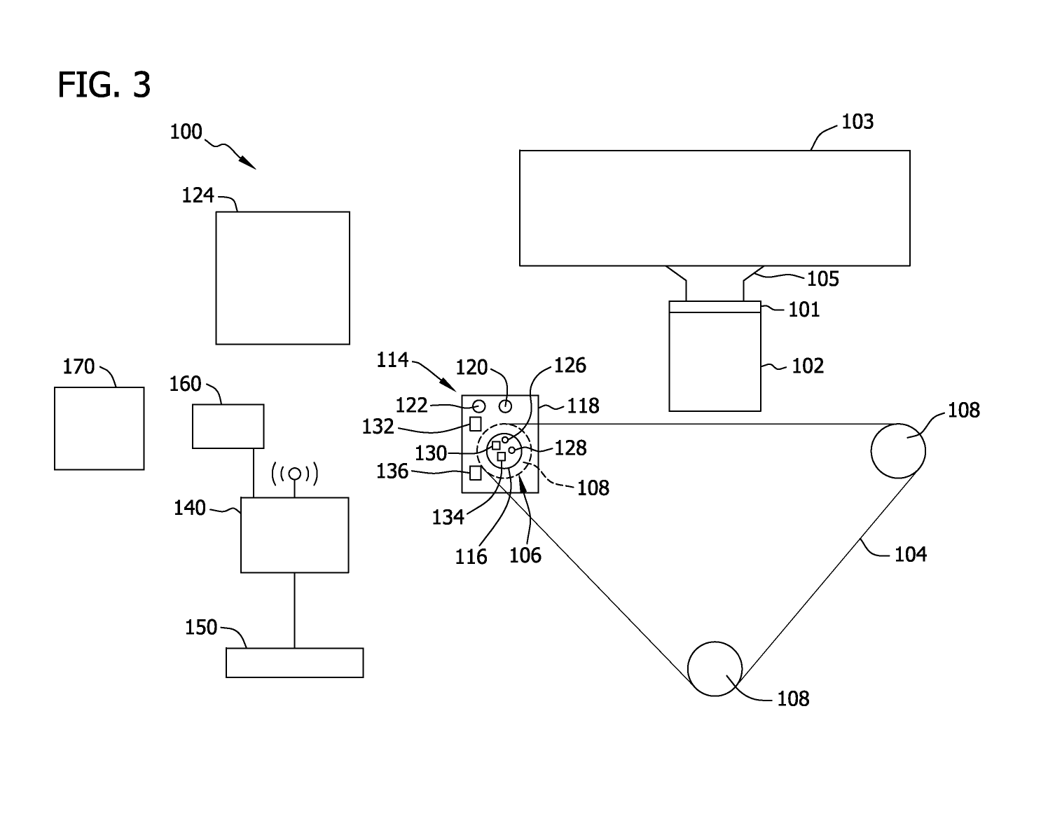

The wire saw 103 (i.e., a wire saw machine) is of the type used to slice (i.e., cut or saw) the ingot 102 into wafers with a web of wires 104. The ingot 102 is connected to a bond beam 101, which is in turn connected to a clamping rail 105. The clamping rail 105 is connected to the wire saw 103. The web of wires 104 (best shown in FIG. 2, only one of the wires is shown in the end view of FIG. 3) travel along a circuitous path around three wire guides 106 when slicing the ingot 102. The number of wires 104 shown in FIG. 2 is greatly reduced for clarity, and their spacing is likewise greatly exaggerated for clarity. One or more of the wire guides 106 may be connected to a drive source to rotate the guides, and in turn the web of wires 104.

In the example embodiment, the wire saw 103 is used to slice ingots 102 made of a semiconductor material (e.g., silicon) or a photovoltaic material. The wire saw 103 may also be used to slice ingots of other materials into wafers.

In this embodiment, the wire guides 106 have opposing ends 108, 110, each of which is connected to a frame 112 (only a portion of which is shown in FIG. 2) of the wire saw 103 by a bearing 114. Each bearing 114 (only one of which is shown in the Figures for clarity) has a rotating race 116 that is connected to a respective end 108 of the wire guide 106 and a stationary race 118 that is connected to the frame 112. The rotating race 116 is best seen in FIG. 3. As its name implies, the rotating race 116 rotates as the wire guide 106 to which it is connected rotates. Likewise, the stationary race 118 does not appreciably move as the rotating race 116 and wire guide 106 rotate. In the example embodiment, the bearings 114 are typical ball bearings, although in other embodiments they may be any other suitable type of bearing (e.g., roller bearings). A temperature-controlling fluid (referred to interchangeably as “fluid”) is in thermal communication with the bearings 114 supporting each wire guide 106 such that the fluid is contact with at least a portion of the bearing or a structure that is in turn in contact with the bearing.

In the example embodiment, each stationary race 118 has an inlet 120 for receiving fresh fluid from a heat exchanger 124 and an outlet 122 for discharging fluid from the race to the heat exchanger. Likewise, each rotating race 116 has an inlet 126 for receiving fresh fluid from the heat exchanger 124 and an outlet 128 for discharging fluid from the race to the heat exchanger. The inlets 120, 126 and outlets 122, 128 are connected to the heat exchanger 124 with pipes, hoses, or other suitable structures (not shown). Only one set of inlets 120, 126 and outlets 122, 128 for one bearing 114 is shown in the Figures for clarity. It should be understood that other bearings have the same or similar configuration and/or number of inlets and outlets. In the example embodiments, only bearings 114 on the left side of the system 100 are movable while bearings on the right side are immovable. The bearings 114 on the left side of the system 100 in the example embodiment are thus the only ones subject to significant displacement and only their displacements can be adjusted. In different embodiments, this is not the case and bearings 114 on both sides of the system may be movable and/or their displacements can be adjusted. Moreover, in some embodiments the immovable (i.e., fixed) bearings may be subject to some degree of displacement during use of the saw and thus their position can be controlled with systems and methods similar to or the same as those described herein.

Moreover, in the example embodiment a single heat exchanger 124 (broadly, a “control system”) is used to control the temperature of the fluid, although in other embodiments, multiple heat exchangers may be used instead. For example, a single heat exchanger may be used to control the temperature of the fluid in contact with the rotating races 116 of all the bearings 114, while another heat exchanger may be used to control the temperature of the fluid in contact with the stationary races 118. The heat exchanger 124 is of any suitable type and is operable to cool and/or heat the fluid. By controlling the temperature of the fluid, the heat exchanger is thus operable to control the temperature of the bearings 114 in thermal communication with the fluid.

A displacement sensor 130 (broadly, a “sensor”) is disposed adjacent the rotating race 116 for measuring movement and/or axial displacement of the race. Likewise, another displacement sensor 132 may be disposed adjacent the stationary race 118 for measuring displacement of the race. In other embodiments, one of these sensors 130, 132 may be omitted. In the example embodiment, these sensors 130, 132 measure axial displacement of the respective races 116, 118 and are non-contact sensors. In other embodiments, the sensors 130, 132 may be configured and/or positioned differently to measure different types of movement of the bearings 114. The sensors 130, 132 are communicatively coupled to a processor 140 (discussed in greater detail below) by any suitable communication system (e.g., a wired and/or wireless network).

Only one of each sensor 130, 132 is shown in the Figures for clarity, although each race of each bearing 114 that is in thermal communication with the fluid has such sensors in the example embodiment. In other embodiments, sensors 130, 132 may be positioned adjacent different bearings 114 or portions thereof to measure displacement of the respective bearings or portions thereof.

Temperature sensors are disposed in thermal communication with the fluid to measure its temperature. In the example embodiment, a temperature sensor 134 is positioned adjacent the rotating race 116 and a temperature sensor 136 is positioned adjacent the stationary race 118. Thus, the temperature sensors 134, 136 are positioned adjacent each race in thermal communication with the fluid that is in turn in thermal communication with the respective races. As the fluid in these locations is in thermal communication with the respective races 116, 118, the temperature of the fluid is indicative of the temperature of the races. In the example embodiment, it is assumed that the temperature of the fluid adjacent to the respective race 116, 118 is generally equal to the temperature of the race. In other embodiments, this may not be the case and the temperature of the fluid adjacent the races 116, 118 differs from the temperature of the race. The temperature sensors 134, 136 are communicatively coupled to the processor 140 (discussed in greater detail below) by any suitable communication system (e.g., a wired and/or wireless network).

The processor, shown schematically in FIGS. 2 and 3 and indicated generally at 140, is communicatively coupled to the temperature sensors 134, 136, the displacement sensors 130, 132, and the heat exchanger 124. Generally, and as discussed in greater detail below, the processor 140 is configured for receiving an input from a user identifying a desired wafer nanotopology profile or shape of wafers sliced from the ingot. Based on this input and the measured temperature of the fluid, the processor 140 communicates instructions to the heat exchanger 124 to control (i.e., adjust, alter or change) the temperature of the fluid. The adjustment of the temperature of the fluid in turn controls the temperature of the portions of the bearings 114 in contact with the fluid, and in turn the other portions of the bearings. This change in temperature of the bearings 114 alters their displacement and that of the wire guides 106 and wires 104. Control of the displacement of the wire guides 106 and wires 104 controls the shape of the surfaces of the wafers, which in turn controls the nanotopology of the surfaces.

The operation of the processor 140 and system 100 are now described in greater detail. An input device 160 (shown schematically in FIGS. 2 and 3) is communicatively coupled to the processor 140 and may be used to receive the input identifying the desired wafer nanotopology or wafer shape from a user. In other embodiments, the processor 140 may receive this input from another computer system communicatively coupled to the processor.

Once this input is received by the processor 140, the processor retrieves a recipe associated with the input from a memory 150. The memory is described in greater detail below. The recipe specifies a temperature set point (i.e., a desired temperature) of the bearings 114 and/or temperature-controlling fluid associated with the recipe. The recipe may also include displacement measurements for the bearings in addition to or in substitution for the temperature set points of the bearings and/or fluid. Adherence to the temperature and/or displacement measurements contained in the recipe during cutting of the ingot 102 by the saw 103 will generally yield wafers having characteristics the same or similar to those as the input. The recipe may be referred to interchangeably as a “temperature profile”, a “displacement profile”, and/or a “temperature displacement profile”.

The recipes can be created according to a variety of different methods. The specific temperatures and/or displacements of each recipe may have been determined experimentally (i.e., during previous slicing operations) or empirically based on the material properties of the bearings 114 (i.e., the co-efficient(s) of thermal expansion of the materials of the bearing). In one embodiment, the recipes are created experimentally by measuring the temperature of the fluid, bearing, and/or the displacement of the bearings 114 during slicing of the ingot 102 and storing these measurements in the memory 150. The surface of at least one of the wafers is then measured and the characteristics of the shape and/or nanotopology of the wafer are then stored in the memory 150. Together with the temperature measurements and/or displacement measurements, these characteristics of the wafer form the recipe. As described below, this process may also be used to periodically update the recipes.

As described above, in the example embodiment the temperature of the bearings 114 is generally equivalent to the temperature of the temperature-controlling fluid that is in thermal communication with the bearings. The recipes are associated with the inputs, such that use of the recipe by the system will result in wafers sliced by the saw 103 having the desired nanotopology and/or shape of the input. These recipes are stored in the memory 150 communicatively coupled to the processor 140. This memory 150 is any suitable form of computer readable media, including tangible storage devices (e.g., a hard disk drive, flash memory, optical drives, etc.).

These temperatures of the fluid will yield changes in position of the bearings 114 that will result in the wafers sliced by the saw having the desired nanotopology and/or shape. In the example embodiment, the processor 140 retrieves the temperature set points from the memory 150.

In operation, the saw 103 then begins slicing the ingot 102 and the processor 140 communicates instructions to the heat exchanger 124 to adjust the temperature of the fluid based on the temperature set point and the measured temperature of the fluid. Once the temperature of the fluid equals that of the temperature set point, the processor 140 sends instructions to the heat exchanger 124 to cease adjusting the temperature of the fluid. The processor 140 may continue to monitor the temperature measurements received from the temperature sensors 134, 136. The processor 140 may send instructions to the heat exchanger 124 to again adjust the temperature of the fluid when its temperature deviates from the temperature set point by more than a variance (e.g., about +/−0.1 degrees Celsius).

In other embodiments, rather than adjust the temperature of the fluid to control the temperature of the bearings, the flow rate of the fluid is adjusted to control the temperature of the bearings. The temperature of the fluid may not be measured and instead the temperature of the bearings 114 is measured by the temperature sensors 134, 136. The temperature sensors 134, 136 are positioned such that they are able to measure the temperature of the bearings 114 (e.g., the sensors are in contact with a portion of the bearings). In such embodiments, the recipe contains a temperature profile describing the temperature set points of the bearings, rather than that of the fluid. The recipes may be generated and updated according to the same or similar methods described herein.

A valve 170 (broadly, a “control system”) is provided in these embodiments to control (i.e., adjust, alter or change) the flow rate of the fluid, which in turn controls the temperature of the bearings 114. The valve 170 is in fluid communication with the inlets 120, 126 and/or outlets 122, 128 via pipes, hoses, or other suitable structures. Multiple valves 170 may be used in some embodiments to control the flow rate of the fluid. Moreover, the valve 170 can be communicatively coupled to the processor 140 by and actuated by an actuator or other suitable device. According to some embodiments, the valve 170 is a proportional control valve although the valve in other embodiments is any suitable valve (e.g., a ball valve or a gate valve). In other embodiments, a variable flow rate pump may be used instead of or in combination with the valve to control the flow rate of the fluid.

When the flow rate of the fluid is increased by the valve 170 (e.g., by opening the valve to a greater extent), the fluid is able to transfer more heat away from the bearing 114. Thus the fluid is able to cool the bearings 114 and reduce their temperature. Decreasing the flow rate of the fluid with the valve 170 (e.g., by closing the valve to a greater extent) has the opposite effect. That is, the reduced flow of fluid is not able to transfer as much heat away from the bearings 114. The temperature of the bearings 114, depending on the flow rate, may thus not decrease as quickly, stay steady, or increase.

This change in temperature of the bearings 114 resultant from the change in flow rate of the fluid alters their displacement and that of the wire guides 106 and wires 104. Control of the displacement of the wire guides 106 and wires 104 controls the shape of the surfaces of the wafers, which in turn controls the nanotopology of the surfaces.

A heat exchanger is thus not used in these embodiments to control the temperature of the fluid. The fluid may be chilled plant water of relatively constant temperature (e.g., between about 5° C. and about 10° C.) that is obtained from a reservoir or other source before being circulated in contact with the bearings 114. After contact with the bearings, the fluid is returned to the reservoir.

In other embodiments, the temperature and displacement of the bearings 114 is controlled by adjusting the flow rate of the fluid in combination with adjusting the temperature of the fluid. The temperature sensors 134, 136 may be used to measure the temperature of the fluid and/or the bearings 114. A valve and/or variable flow rate pump as described above can be used to adjust the flow rate of the fluid to control the temperature of the bearings 114. The heat exchanger 124 described above can be used to control the temperature of the fluid. In such embodiments, the recipes also contain the temperature set points of the bearings in addition to the temperature set points of the fluid.

According to some embodiments, the temperature set points are also determined based on a measured displacement of the stationary race 118 and/or rotating race 116 of the bearing 114. For example, if the measured displacement of the bearing 114 is within a range of displacements specified by the recipe, the temperature set point may be adjusted such that the temperature of the fluid in thermal communication with the bearing and/or the flow rate of the fluid is not altered. The measured displacement of the bearing 114 may thus act as feedback to the processor to adjust the temperature set point.

In some embodiments, the recipes may be updated after slicing operations by measuring the surfaces of the wafers sliced from the ingot. For example, the surface of the wafers may be measured and compared to the desired wafer shape and/or nanotopology profile input by the user. If the measurements of the surface differ from those input by the user, the recipe may be updated. This update may comprise adjusting the temperature set points of the fluid and/or flow rate of the fluid included in the recipe. The update can also include adjustments in the desired displacements of the portions of the bearings 114.

In another embodiment, the displacement of the bearings 114 is measured by the displacement sensors 130, 132 at set intervals during slicing of the ingot 102. The displacement measurements are then received by the processor 140. In response to the received measurements, the processor 140 determines the temperature set point of the bearings 114 necessary to reduce or eliminate their displacement and ameliorate the negative affects that such displacement can have on the wafers.

The processor 140 then communicates instructions to the heat exchanger 124 to control the temperature of the fluid based at least in part on the measured displacement of the bearings 114. In embodiments using the valve 170, the processor 140 can also communicate instructions to the valve to control the flow rate of the fluid. These instructions to the valve 170 are also based at least in part on the measured displacement of the bearings 114. The resultant actions of both the heat exchanger 124 and the valve 170 control the temperature of the bearings 114, which in turn controls displacement of the bearings. Moreover, the instructions generated by the processor 140 may also be based at least in part on one or more recipes stored in the memory 150.

In one example, the processor 140 may determine temperature set point based on the measured displacement of the bearings 114 or portions thereof. The processor then communicates instructions to the heat exchanger 124 to cool the fluid based on the measured displacement of the bearings or portions thereof. The reduction in temperature of the fluid reduces the temperature of the bearings 114, which in reduces or eliminates their displacement. The temperature sensors 134, 136 may also be used to measure the temperature of the fluid and/or bearings 114 and communicate these temperature measurements to the processor 140. These temperature measurements function as feedback for the processor 140.

In still other embodiments, only the temperature of the fluid is controlled and the displacement of the bearings 114 is not measured during slicing of the ingot 102. In these embodiments, the heat exchanger 124 controls the temperature of the fluid to control the temperature of the bearings 114 according to a temperature set point. This temperature set point may be retrieved from a recipe as described above. Alternatively, it may be received as an input to the system 100 from a user or other computer system. The system 100 may measure the temperature of the fluid with the respective sensors 134, 136 in some embodiments and use the measurement as feedback to control the heat exchanger 124.

In yet other embodiments, only the flow rate of the fluid is controlled and the displacement of the bearings 114 is not measured during slicing of the ingot 102. In these embodiments, the valve 170 controls the flow rate of the fluid to control the temperature of the bearings 114 according to a temperature set point. This temperature set point may be retrieved from a recipe as described above. Alternatively, it may be received as an input to the system 100 from a user or other computer system. The system 100 may measure the temperature of the bearing 114 with the respective sensors 134, 136 in some embodiments and use the measurement as feedback to control the valve 170.

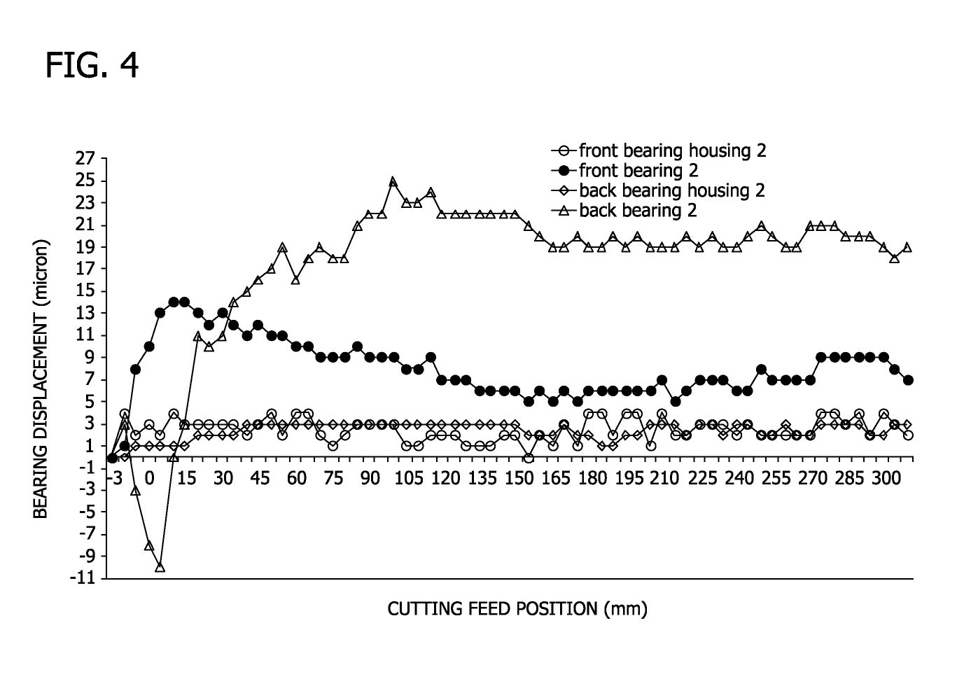

The systems and methods described herein control the nanotopology and shape of wafers cut in a wire saw machine 103. It has been determined that in prior systems, often the bearings 114 or portions thereof are subject to displacement or move during slicing of the ingot 102. Graph 1 shows experimental data illustrating this changing displacement of the bearings 114. As shown in the Graph of FIG. 4, the displacement of the stationary races 118 may remain relatively constant during slicing of the ingot 102 by the wire saw 103. Displacement of the rotating races 116, however, is readily apparent. As such, the system 100 in the example embodiment is directed to controlling the displacement of the rotating race 116. In other embodiments, the displacement of the stationary race 118 may be controlled in conjunction with or substitution of displacement of the rotating race 116.

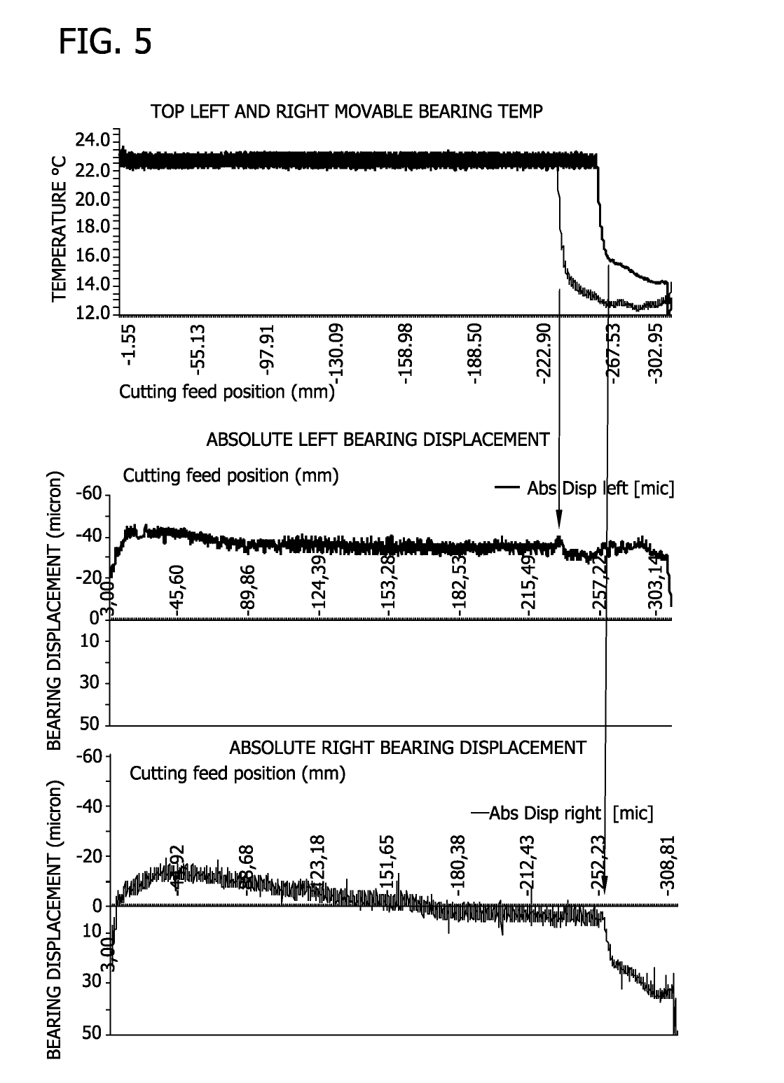

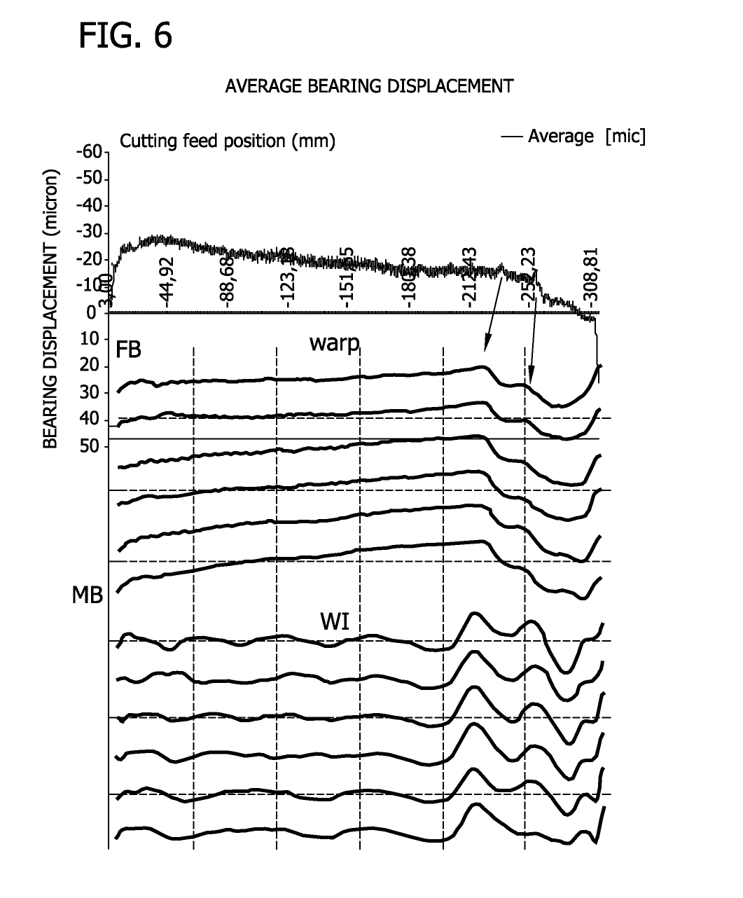

This displacement of the bearings 114 causes displacement of the wire guides 106 and wires 104 of the saw 103. This displacement of the wire guides 106 and wires 104 in turn causes defects in the shape and/or nanotopology of wafers sliced from the ingot 102. Entry and exit marks are types of such defects. It is believed that the displacement of the bearings 114 is caused by a change in temperature of the bearings, and thus a change in temperature of the fluid in thermal communication with the bearings. The Graph of FIG. 5 shows experimental data illustrating this correlation between the temperature of the bearings and their displacement. The Graph of FIG. 6 shows experimental data illustrating the correlation between bearing displacement and wafer shape. In particular, the uppermost data set represents the average displacement of the bearing, while the middle data set (comprising data series for six wafers) represents the warp measurements taken of wafers. The lower data set (comprising data series for the same six wafers) represents a WI measurement of the wafers. WI is a mathematical transformation of the warp measurements which is a prediction of the nanotopology of the wafer after it is polished. “FB” and “MB” identify the locations of wafers with respect to the wire saw 103.

By controlling the temperature of the fluid in contact with the bearings 114, the systems and methods described herein control the temperature of the bearings. Moreover, controlling the flow of the fluid can by used in addition to or in place of the fluid temperature control to control the temperature of the bearings. The control of the temperature of the bearings 114 in turn controls their displacement. Accordingly, the displacement of the bearings 114 can be minimized or eliminated by controlling their temperature. By doing this, the displacement of the wire guides 106 and wires 104 can be minimized or eliminated as well. As such, defects (e.g., entry or exit marks) in the shape of the wafers and/or their nanotopology can be reduced or eliminated. This reduction in defects increases the yield of the wafer manufacturing process. Furthermore, down stream processing operations (e.g., double-side grinding) may be reduced in duration or eliminated, thus reducing the time and cost of manufacturing the wafers.

The systems and methods also permit a user to control the shape and/or nanotopology of the wafers, in addition to or in place of reducing or eliminating other defects (e.g., entry or exit marks). A user is thus able to input a desired shape and/or nanotopology profile of wafers sliced from the ingot 102. Users may desire for wafers to have differing shapes and/or nanotopology for a variety of reasons.

For example, wafers which are subject to an epi-deposition process may be bowed or warped to some degree by the process. In these instances, the shape of the wafers may be controlled by the above system 100 during slicing of the ingot 102 such that the wafers have a warp or bow that is opposite of that caused by the epi-deposition process. For example, if a later-performed epi-deposition process tends to bow wafers in a convex direction, the shape of the wafers may be controlled by the system such that they are concave after being sliced. Accordingly, once the wafers are later subject to the epi-deposition process, the concave shape of the wafers will counteract the tendency of the process to warp the wafer in a convex direction. This will result in the wafers have a substantially flat shape after the epi-deposition process is completed.

When introducing elements of the present disclosure or the embodiments thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the present disclosure, it is intended that all matter contained in the above description and shown in the accompanying drawings shall be interpreted as illustrative and not in a limiting sense.

What is claimed is:

1. A system for controlling the surface profile of wafers sliced from an ingot in a wire saw, the wire saw including a wire guide supporting wires, the wire guide rotating on a bearing, and a fluid in thermal communication with the bearing, the system comprising:
a memory for storing temperature profiles, each temperature profile associated with a surface profile and defining a temperature set point for at least one of the fluid and the bearing;
a control system for controlling the temperature of the bearing;
a temperature sensor for measuring the temperature of at least one of the fluid and the bearing; and
a processor communicatively coupled to the memory, control system, and temperature sensor, the processor configured for receiving an input identifying a desired surface profile and retrieving the associated temperature set point from the memory, the processor configured for communicating instructions to the control system to control the temperature of the bearing based at least in part on the temperature set point and measured temperature of at least one of the fluid and the bearing.

2. The system of claim 1 further comprising a sensor connected to the processor and disposed for measuring displacement of the bearing of the wire guide.

3. The system of claim 2 wherein the sensor is a first sensor and is disposed for measuring displacement of a rotating race of the bearing.

4. The system of claim 3 further comprising a second sensor disposed for measuring displacement of a stationary race of the bearing.

5. The system of claim 1 further comprising an input device for receiving the input identifying the desired surface profile, the input device communicatively coupled to the processor.

6. The system of claim 1 wherein the control system comprises at least one of a heat exchanger for controlling the temperature of the fluid and a valve for controlling a flow rate of the fluid.

7. A system for controlling surface profiles of wafers cut from an ingot by a wire saw, the system comprising:
a wafer measurement sensor for measuring a surface of the wafer previously cut by the wire saw;
a sensor disposed for measuring displacement of a bearing of a wire guide supporting wires in the wire saw; and
a processor for determining a temperature set point, the processor configured for determining the temperature set point based at least in part on one of the measured displacement of the bearing and measured surface of the previously cut wafer, the processor communicatively coupled to the wafer measurement sensor and the sensor.

8. The system of claim 7 wherein the sensor is disposed for measuring displacement of at least one of a rotating race of the bearing and a stationary race of the bearing.

9. The system of claim 7 wherein the sensor is a first sensor for measuring displacement of a rotating race of the bearing and further comprising a second sensor for measuring displacement of a stationary race of the bearing.

10. The system of claim 7 further comprising a heat exchanger for controlling the temperature of the fluid, the heat exchanger communicatively coupled to the processor.

11. The system of claim 7 further comprising a memory for storing at least one of the set point and the measurements of the surface of the previously cut wafer.

12. The system of claim 7 further comprising a temperature sensor for measuring the temperature of the fluid, wherein the temperature sensor is communicatively coupled to the processor.

13. A system for controlling the surface profile of wafers sliced from an ingot in a wire saw, the wire saw including a wire guide supporting wires, the wire guide rotating on a bearing, and a fluid in thermal communication with the bearing, the system comprising:
a memory for storing temperature profiles, each temperature profile associated with a surface profile and defining a temperature set point for the bearing;
a valve for controlling the flow rate of the fluid;
a temperature sensor for measuring the temperature of the bearing; and
a processor communicatively coupled to the memory, valve, and temperature sensor, the processor configured for receiving an input identifying a desired surface profile and retrieving the associated temperature set point from the memory, the processor configured for communicating instructions to the valve to control the flow rate of the fluid based at least in part on the temperature set point and measured temperature of the bearing.

14. The system of claim 13 further comprising a sensor connected to the processor and disposed for measuring displacement of the bearing of the wire guide.

15. The system of claim 14 wherein the sensor is a first sensor and is disposed for measuring displacement of a rotating race of the bearing.

16. The system of claim 15 further comprising a second sensor disposed for measuring displacement of a stationary race of the bearing.

17. The system of claim 13 further comprising an actuator for controlling the valve, the actuator communicatively coupled to the processor.

18. The system of claim 13 further comprising a fluid temperature sensor for measuring the temperature of the fluid, wherein the fluid temperature sensor is communicatively coupled to the processor.

19. The system of claim 18 further comprising a heat exchanger for controlling the temperature of the fluid.

20. The system of claim 19 wherein each temperature profile further defines a temperature set point for the fluid, and wherein the processor is configured for communicating instructions to the heat exchanger to control the temperature of the fluid based at least in part on the temperature set point and measured temperature of the fluid.
